(19) United States
(12) Patent Application Publication
(10) Pub. No.: US 2007/0256356 A1
(43) Pub. Date: Nov. 8, 2007

(54) System and Method for the Cultivation/Movement of Plants

(76) Inventor: Cornelis Kap, Honselersdijk (NL)

Correspondence Address: ABELMAN, FRAYNE & SCHWAB, 666 THIRD AVENUE, 10TH FLOOR, NEW YORK, NY, 10017, US

(21) Appl. No.: 10/591,569

(22) PCT Filed: Mar. 3, 2005
(86) PCT No.: PCT/NL05/00157

§ 371 Date: Jun. 21, 2007

(30) Foreign Application Priority Data
Mar. 3, 2004 (NL) 1025625

(51) Int. Cl. A01M 7/00

(52) U.S. Cl. 47/1.7

(57) ABSTRACT

System (1) and method for removing plants from a cultivation area (2) or, alternatively, placing plants therein. Such plants are preferably pot plants, but can also be other plants, for example placed in trays. A feed/removal belt (4) extends along the cultivation surface (2). Perpendicularly thereto there is a branch conveyor (17), likewise constructed as a conveyor belt. A much wider collection belt (5) is arranged, once again perpendicular thereto, that is to say parallel to the feed/removal conveyors (4). Interacting with this there is a distribution device (6) that extends over the depth of the cultivation surface (2) and has a fork (16) which is able to remove the plants from the collection conveyor (5) or, alternatively, place them thereon and set them down on the cultivation surface (2) or pick them therefrom, respectively.

The present invention relates to a system for the cultivation/movement of plants, comprising a feed/removal conveyor extending adjacent to the cultivation surface and means for moving plants from/to said feed/removal conveyor in a direction perpendicular to the direction of movement of said feed/removal conveyor in said cultivation surface. Such a system is generally known in the state of the art. A system where pot plants are cultivated on stationary conveyor belts, which conveyor belts extend perpendicularly to the feed/removal conveyor, is mentioned as an example. The conveyor belts are operated as required and an entire series of plants can be brought to the feed/removal conveyor or vice versa. Such a system appreciably increases the accessibility of the plants and it is possible in a simple manner to perform operations thereon.

Such a system has a number of disadvantages. Firstly, it is not possible to reach the “rearmost” of a series of plants in a simple manner. For this purpose it is necessary that the entire series is unloaded onto the feed/removal conveyor by means of the conveyor belt and only then can the “rearmost” plant be reached. A further disadvantage is the high cost price of such a system. Moreover, the conveyor belts are a distance apart that corresponds to the desired dimensions of the pots. If it is necessary to change to larger or smaller pots problems arise in the width as a result of lack of space or insufficient utilisation of the space. Consequently, such a system cannot be employed flexibly.

EP 0 917 817 discloses a system for pricking out plants. WO 02/052922 describes the removal of an individual plant from a bed and placing it in a pot.

The aim of the present invention is to provide a system that does not have the disadvantages described above. This aim is realised with the system as described above in that said means comprise a collection conveyor, adjoining said feed/removal conveyor, and a distribution device, said distribution device comprising a fork-like construction, for picking up/setting down the plant, fixed to a carriage that can be moved between a pick-up/set-down position for said fork-like construction at the collection conveyor and a set-down/pick-up position in said cultivation surface.

According to the present invention movement of the plants and more particularly pot plants takes place in two steps. When placing plants on/in a cultivation surface these are first branched off from the feed/removal conveyor and placed on a collection conveyor. Such a collection conveyor can have a large capacity in a direction perpendicular to the transport direction thereof, that is to say the plants can be placed next to one another. This is in contrast to conventional feed/removal conveyors on which only one plant can be arranged. Moreover, the use of such a collection conveyor creates the possibility for carrying out the second step in an accurately controlled manner. This second step consists of grasping the plants, lifting them followed by moving above the cultivation surface and setting down in the desired position. This is effected, in particular, using a fork-like construction. Such a fork-like construction is suitable both for grasping pot plants and plants that grow in trays and the like. The cultivation surface can be the concrete floor of a greenhouse, but this can also be a roller table, roller trough or other cultivation surface that is known in the art. The fork-like construction can comprise any construction known in the art, that is to say a construction that moves over the floor surface of the greenhouse or a construction that is suspended from one or other type of rail or other construction fixed in the greenhouse.

Preferably, an auxiliary construction is used to transfer the plants, such as pot plants, from the feed conveyor to the collection conveyor. Such an auxiliary construction preferably comprises a branch conveyor.

This preferably extends perpendicularly to the feed/removal conveyor and specific plants are moved from the feed/removal conveyor onto the branch conveyor using suitable means. The collection conveyor itself preferably extends perpendicularly to the branch conveyor. The branch conveyor can have a length of a few metres to a few tens of metres. That is to say this can extend over an appreciable length in the cultivation area. By providing the branch conveyor with, for example, pusher members or other constructions it is possible to move a group of plants that are in the longitudinal direction on the branch conveyor into the width of the relatively broad collection conveyor. As a result it is possible to position a large number of plants one behind the other and next to one another on the collection conveyor. With the fork-like construction it is then again possible to pick up a large number of plants simultaneously from the collection conveyor. Moreover, during this treatment it is possible to set or, alternatively, to change the spacing of the plants in an accurate manner so that the plants are grasped by the fork-like construction in a guaranteed manner. In this way a number of rows located next to one another are grasped and moved with the fork-like construction.

It will be understood that the process described above can also be carried out in the reverse sequence, that is to say plants can be picked up from the cultivation surface with a fork-like construction and finally can arrive on the feed/removal conveyor.

It will also be understood that using the present invention it is possible to pick up a single row of plants and also each row can contain a large or small number of plants. In the extreme case only one plant can be picked up using the fork-like construction.

It is also possible to construct the system described above as a dual system, that is to say to provide two feed/removal conveyors, which, for example, are parallel and some distance apart, and to carry out the collection and distribution described above between them.

Using the present invention it is possible to pick up a specific plant or specific group of plants at a specific point on the cultivation surface without the other plants on the cultivation surface having to be moved for this purpose, as was necessary in the art. Moreover, the construction described above is much less expensive to produce and can easily be adapted to plants of different size by making adjustments to the fork-like construction.

A further saving in costs can be obtained if the fork-like construction can be moved along a carriage, which carriage runs on (high or low) horizontal rails installed in the cultivation surface. By this means a very wide surface can be covered by one fork of relatively restricted width.

An even wider surface can be covered if the construction consisting of collection conveyor and distribution device can be moved between different positions, such as different bays of a greenhouse, in a direction parallel to the feed/removal conveyor.

The invention also relates to a method for the cultivation/movement of plants, comprising feeding/removing a group of said plants in a first horizontal direction, diverting some of said plants from the group in a second horizontal direction at an angle to said first horizontal direction and collecting said diverted plants in a third horizontal direction parallel to said first direction, picking-up said collected plants on raising them and moving said collected plants in a horizontal fourth direction at an angle to said first direction and, on lowering said plants, setting them down on a cultivation surface and vice versa.

The invention will be explained in more detail below with reference to an illustrative embodiment shown in the drawing. In the drawing the figures show:

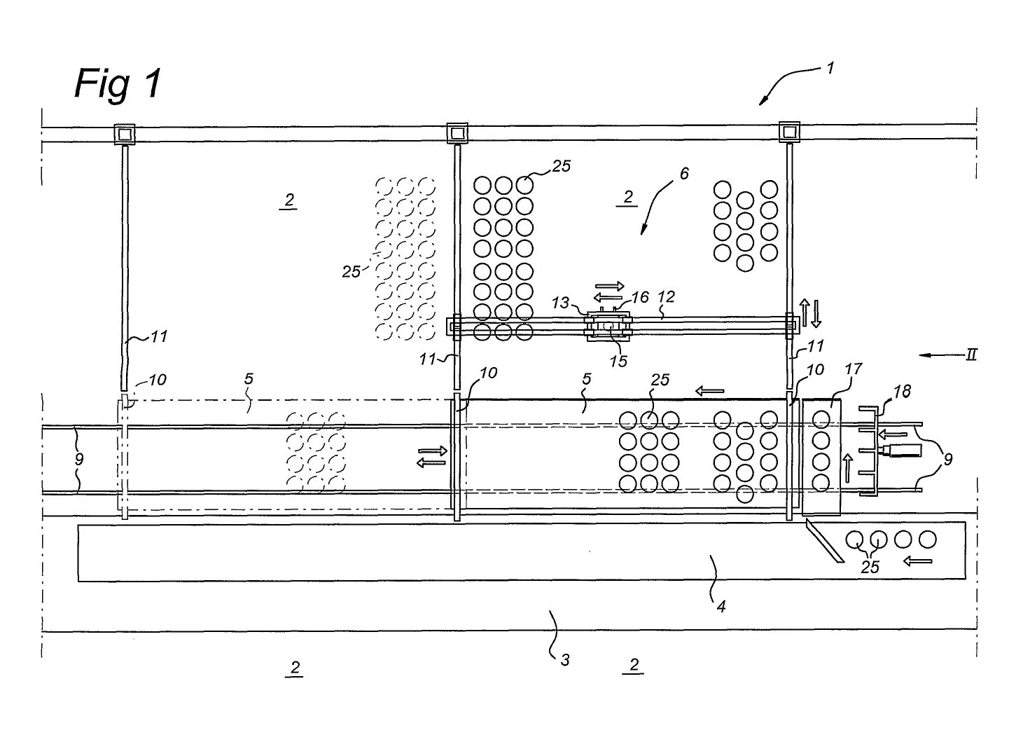

FIG. 1 diagrammatically, a plan view of the system according to the present invention;

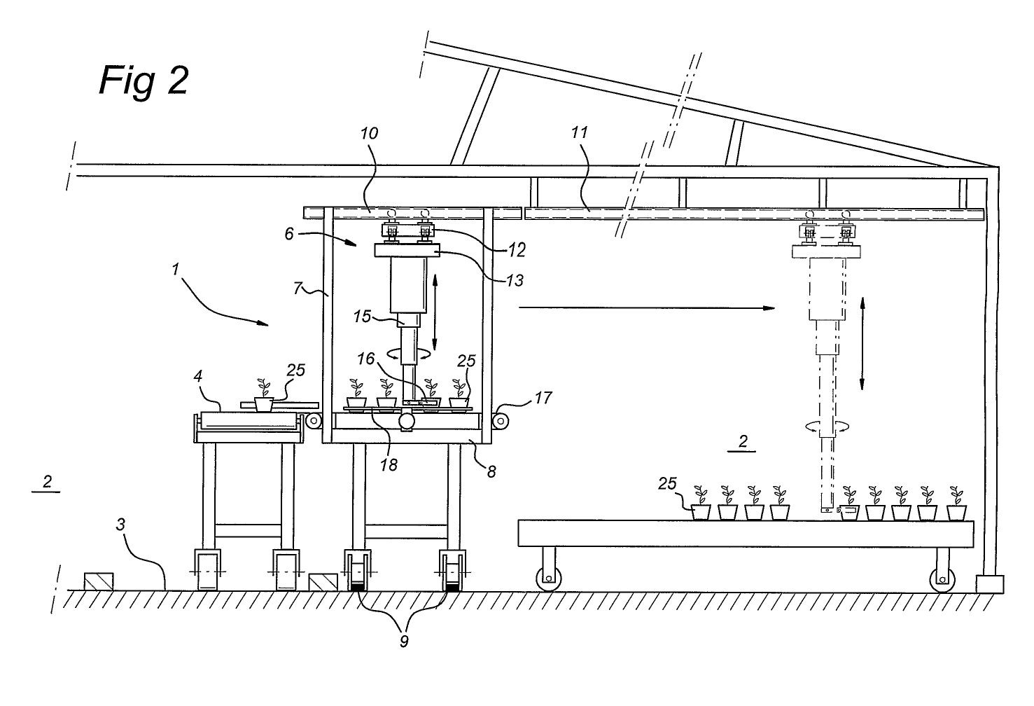

FIG. 2 a side view of the installation according to FIG. 1.

The system according to the present invention is indicated in its entirety by 1 in FIG. 1 and FIG. 2. This system is used in an area comprising various cultivation areas 2. The cultivation areas 2 are, for example, delimited by the bays of a greenhouse.

There is a gangway 3 at the “front” end. It will be understood that there can be yet further cultivation areas 2 adjacent to this. A feed/removal conveyor 4 that extends along the entire front wall of the greenhouse or other area in which the cultivation areas 2 are accommodated is positioned in the gangway 3. According to the present invention, there is a branch conveyor 17 extending away therefrom, which is adjoined by a collection conveyor 5. As can be seen from the drawing, the feed/removal conveyor is designed to transport a single row of pot plants 25. The same applies for the branch conveyor 17. The collection conveyor is several pot plants 25 “wide”.

There is a distribution device 6 that can be moved along rails 11. Rails 11 are installed in a fixed position in the greenhouse. The distribution device 6 consists of a portal or carriage 12 provided with a sled 13 which can be moved along portal 12, that is to say in the transverse direction with respect to rail 11. An arm 14 comprising a cylinder 15, to the other end of which a fork 16 is fitted (such that it can turn), is fixed to the sled. Fork 16 can move up and down in the vertical direction with the cylinder 15. There are motor means (not shown) to move portal 12 along the rails 11.

Branch conveyor 17 and collection conveyor 5 are mounted on a subframe 8 that can be moved along rails 9 in a direction parallel to the feed/removal conveyor. Furthermore, there is a frame 7 connected to the branch conveyor, to which frame the above-mentioned rails 10 are fixed.

Branch conveyor 17 is provided with a pusher member 18. Both the branch conveyor 17 and collection conveyor 5 are simple conveyor belts provided with a control.

The installation described above functions as follows. If a specific cultivation area has to be provided with plants, pot plants 25, for example, are fed via conveyor 4. In a manner that is not shown in more detail, these pot plants are diverted to branch conveyor 17 and rows of pot plants 25 are placed on the collection conveyor 5 with the pusher member 18. By means of suitable control of the movement of the collection conveyor, the mutual spacing of the row can be accurately determined and changed if necessary. What is achieved by this means is that in each row the plants are both accurately in line one behind the other and that the spacing between each row is precisely defined. This is important for the subsequent step. In this step the fork is lowered to above the surface of the collection conveyor 5. During this operation the free ends of the prongs of the fork can be oriented either towards the cultivation area 2 or can be oriented towards the feed/removal conveyor. Because the fork 16 is designed to correspond to the size of the plants that have to be moved, a guaranteed engagement can be ensured after pushing the prongs of the fork between the series of plants. Arm 14, and thus fork 16 together with the plants, are then raised with the aid of cylinder 15. Portal 12 then first moves along rails 10 which are installed in line with rails 11. This portal then moves along rails 11 and if the desired set-down position for the plants has been reached the fork 16 is lowered to the cultivation surface. After setting down the plants 25, the fork 16 is then moved back and a subsequent operation can take place. It will be understood that this operation can also be reversed for removing plants from a cultivation surface.

If a following bay has to be subjected to a corresponding treatment, the subframe 8 with distribution device 6 located on the rails 10 is moved one position to the left or to the right as seen in FIG. 1. It will be understood that a large number of rows located next to one another can be moved using the present invention. It is also possible to move a smaller number of rows or a smaller number of plants per row. It is also possible to provide a specific floor surface with plants in a back and forth movement of the distribution device 16 and then to remove plants from an immediately adjacent floor surface. This can be important, for example for placing further apart. In such a case the plants that have just been picked up can, after having been placed on the collection belt, also be moved back only a slight distance on the feed/removal conveyor. After all, as a result of the combination of the branch belt and the collection belt, setting wider apart can be achieved in a simple manner.

It will be understood that the system according to the present invention offers numerous logistical options. The construction can be modified depending on the use demanded. For instance, it is possible, instead of a single branch conveyor 17, to install such a branch conveyor on either side of the collection belt, as a result of which feed/removal can be further optimised. Further modifications can also be conceived by those skilled in the art and are immediately apparent on reading the above description and fall within the scope of the present invention.

1. System for the cultivation/movement of plants, comprising a feed/removal conveyor extending adjacent to the cultivation surface and means for moving plants from/to said feed/removal conveyor in a direction perpendicular to the direction of movement of said feed/removal conveyor in said cultivation surface, said means comprising a collection conveyor adjoining said feed/removal conveyor, and a distribution device, said distribution device comprising a fork-like construction for picking up/setting down the plant, fixed to a carriage that can be moved between a pick-up/set-down position for said fork-like construction at the collection conveyor and a set-down/pick-up position in said cultivation surface.

2. System according to claim 1, wherein said fork-like construction is designed for engaging a series of plants.

3. System according to claim 1, having a branch conveyor positioned between said feed/removal conveyor and said collection conveyor.

4. System according to claim 1, wherein said conveyors have a surface supporting the plants.

5. System according to claim 4, wherein there is a guide for said distribution device extending perpendicularly to said feed/removal conveyor over said cultivation surface.

6. System according to claim 5, wherein said fork-like construction can be moved with respect to said carriage in a direction parallel to said feed/removal conveyor.

7. System according to claim 6, wherein said collection conveyor can be moved in a direction parallel to the feed/removal conveyor.

8. System according to claim 7, having a branch conveyor that can be moved with said collection conveyor in said direction parallel to the feed/removal conveyor.

9. System according to claim 7, wherein said distribution device can be moved in a direction parallel to the feed/removal conveyor.

10. Method for the cultivation/movement of plants, comprising feeding/removing a group of said plants in a first horizontal direction, diverting some of said plants from the group in a second horizontal direction at an angle to said first horizontal direction and collecting said diverted plants in a third horizontal direction parallel to said first direction, picking-up said collected plants on raising them and moving said collected plants in a horizontal fourth direction at an angle to said first direction and, on lowering said plants, setting them down on a cultivation surface and vice versa.

11. Method according to claim 10, wherein, after/when collecting said plants and/or when picking up said collected plants, said collected plants are moved in a direction parallel to said first direction.

12. Method according to claim 10, comprising first clearing a cultivation surface according to claim 10 and then providing plants on/in said cultivation surface according to claim 10.

13. System according to claim 2, having a branch conveyor positioned between said feed/removal conveyor and said collection conveyor.

14. System according to claim 2, wherein said conveyors have a surface supporting the plants.

15. System according to claim 3, wherein said conveyors have a surface supporting the plants.

16. System according to claim 1, wherein there is a guide for said distribution device extending perpendicularly to said feed/removal conveyor over said cultivation surface.

17. System according to claim 2, wherein there is a guide for said distribution device extending perpendicularly to said feed/removal conveyor over said cultivation surface.

18. System according to claim 1, wherein said fork-like construction can be moved with respect to said carriage in a direction parallel to said feed/removal conveyor.

19. System according to claim 2, wherein said fork-like construction can be moved with respect to said carriage in a direction parallel to said feed/removal conveyor.

20. System according to claim 1, wherein said collection conveyor can be moved in a direction parallel to the feed/removal conveyor.

21. Method according to claim 11, comprising first clearing a cultivation surface according to claim 11 and then providing plants on/in said cultivation surface according to claim 11.
